(19) United States
(12) Patent Application Publication
(10) Pub. No.: US 2025/0391188 A1
(43) Pub. Date: Dec. 25, 2025

(54) IMAGE PROCESSING APPARATUS, IMAGE PROCESSING SYSTEM, OUTPUT APPARATUS, IMAGE PROCESSING METHOD, AND RECORDING MEDIUM IN WHICH IMAGE PROCESSING PROGRAM IS RECORDED

(71) Applicant: SHARP KABUSHIKI KAISHA, Osaka (JP)

(72) Inventor: DAISUKE IGARASHI, Osaka (JP)

(21) Appl. No.: 19/230,620

(22) Filed: Jun. 6, 2025

(30) Foreign Application Priority Data
Jun. 19, 2024 (JP) 2024-098668

(51) Int. Cl. G06V 30/148; G06V 30/19

(52) U.S. Cl. CPC G06V 30/153; G06V 30/19147

(57) ABSTRACT

An image processing apparatus includes an acquisition processing unit that acquires character image data, a character sequence extraction processing unit that extracts a character-sequence rectangle corresponding to a character sequence composed of a plurality of characters from the character image data, a one-character extraction processing unit that extracts a plurality of one-character rectangles corresponding to the plurality of characters, respectively, from the character image data, a correction processing unit that corrects a specific one-character rectangle when the plurality of one-character rectangles include the specific one-character rectangle, at least one of a position and a size of the specific one-character rectangle satisfying a predetermined condition, and a recognition processing unit that executes character recognition processing on the character sequence using the specific one-character rectangle corrected by the correction processing unit.

### INCORPORATION BY REFERENCE

This application is based upon and claims the benefit of priority from the corresponding Japanese Patent Application No. 2024-098668 filed on Jun. 19, 2024, the entire contents of which are incorporated herein by reference.

### BACKGROUND

The disclosure relates to a technique for executing image processing such as character recognition on an input image.

Techniques for recognizing characters handwritten on documents, forms, and the like (OCR processing) are known in the related art. For example, a technique in which handwritten portions and background portions are estimated in a scanned image, contours present within a processing target region of the scanned image are extracted, and the results of the estimation are corrected based on the coordinate positions of the extracted contours, the coordinate positions of the estimated handwritten portions, and the coordinate positions of the estimated background portions is known.

However, in the related art, when a handwritten character sequence includes a small-size handwritten character, for example, a comma, a period, a punctuation mark, or the like, there may be a problem that such a small-size handwritten character is misrecognized as a large-size character. For example, when a character sequence “99,600-” included in an input image is subjected to OCR processing, a problem that the comma “,” is misrecognized as “9” and “999600-” may be output as an OCR result may occur.

### SUMMARY

An object of the disclosure is to provide an image processing apparatus, an image processing system, an output apparatus, an image processing method, and a recording medium in which an image processing program is recorded that are capable of improving character recognition accuracy for character sequences including small-size handwritten characters.

According to an aspect of the disclosure, an image processing apparatus includes an acquisition processing unit, a first extraction processing unit, a second extraction processing unit, a correction processing unit, and a recognition processing unit. The acquisition processing unit acquires character image data. The first extraction processing unit extracts a character-sequence rectangle corresponding to a character sequence composed of a plurality of characters from the character image data. The second extraction processing unit extracts a plurality of one-character rectangles corresponding to the plurality of characters, respectively, from the character image data. The correction processing unit corrects a specific one-character rectangle when the plurality of one-character rectangles include the specific one-character rectangle, at least one of a position and a size of the specific one-character rectangle satisfying a predetermined condition. The recognition processing unit executes character recognition processing on the character sequence using the specific one-character rectangle corrected by the correction processing unit.

According to an aspect of the disclosure, an image processing system includes the image processing apparatus and a training apparatus that generates a trained model by performing machine learning using the training data generated by the image processing apparatus.

According to another aspect of the disclosure, an output apparatus executes character recognition processing on an input image using the trained model generated by the training apparatus and outputs a character recognition result.

According to another aspect of the disclosure, an image processing method is performed by one or more processors, the image processing method including acquiring character image data, extracting a character-sequence rectangle corresponding to a character sequence composed of a plurality of characters from the character image data, extracting a plurality of one-character rectangles corresponding to the plurality of characters, respectively, from the character image data, correcting a specific one-character rectangle when the plurality of one-character rectangles include the specific one-character rectangle, at least one of a position and a size of the specific one-character rectangle satisfying a predetermined condition, and executing character recognition processing on the character sequence using the corrected specific one-character rectangle.

According to another aspect of the disclosure, a recording medium has an image processing program recorded thereon, the image processing program causing one or more processors to acquire character image data, extract a character-sequence rectangle corresponding to a character sequence composed of a plurality of characters from the character image data, extract a plurality of one-character rectangles corresponding to the plurality of characters, respectively, from the character image data, correct a specific one-character rectangle when the plurality of one-character rectangles include the specific one-character rectangle, at least one of a position and a size of the specific one-character rectangle satisfying a predetermined condition, and execute character recognition processing on the character sequence using the corrected specific one-character rectangle.

According to the disclosure, it is possible to provide an image processing apparatus, an image processing system, an output apparatus, an image processing method, and a recording medium in which an image processing program is recorded that are capable of improving character recognition accuracy for character sequences including small-size handwritten characters.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a function block diagram illustrating a configuration of an image processing system according to an embodiment of the disclosure.

FIG. 2 is a diagram illustrating an example (receipt) of an input image according to an embodiment of the disclosure.

FIG. 3 is a diagram illustrating an example (receipt) of an input image according to an embodiment of the disclosure.

FIG. 4 is a diagram illustrating a specific example of character recognition processing according to an embodiment of the disclosure.

FIG. 5 is a diagram illustrating the specific example of the character recognition processing according to the embodiment of the disclosure.

FIG. 6 is a diagram illustrating the specific example of the character recognition processing according to the embodiment of the disclosure.

FIG. 7 is a diagram illustrating the specific example of the character recognition processing according to the embodiment of the disclosure.

FIG. 8 is a flowchart illustrating an example of the procedure of character recognition processing executed in an image processing apparatus according to an embodiment of the disclosure.

FIG. 9 is a diagram illustrating a specific example of the character recognition processing according to an embodiment of the disclosure.

FIG. 10 is a diagram illustrating the specific example of the character recognition processing according to the embodiment of the disclosure.

FIG. 11 is a diagram illustrating the specific example of the character recognition processing according to the embodiment of the disclosure.

### DETAILED DESCRIPTION

Embodiments of the disclosure will be described below with reference to the drawings. Note that the following embodiments are specific examples of the disclosure, and do not limit the technical scope of the disclosure.

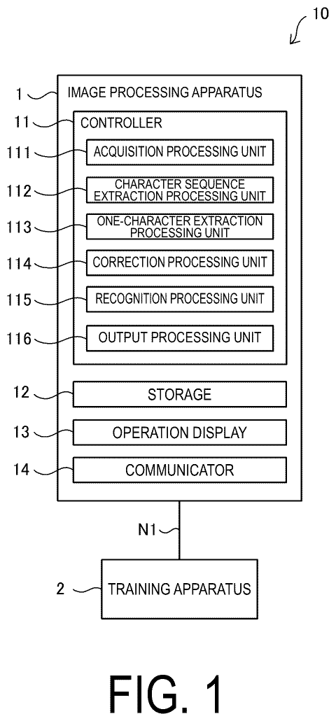

FIG. 1 is a block diagram illustrating a configuration of an image processing system 10 according to an embodiment of the disclosure. The image processing system 10 includes an image processing apparatus 1 and a training apparatus 2. The image processing apparatus 1 is an information processing apparatus that recognizes character sequences included in an input image (image data), executes character recognition processing (OCR processing) on the recognized character sequence, and outputs character recognition results. The training apparatus 2 is an information processing apparatus that performs machine learning using input data (training data) input from the image processing apparatus 1 to generate a trained model for performing character recognition on input images.

As illustrated in FIG. 1, the image processing apparatus 1 includes a controller 11, a storage 12, an operation display 13, a communicator 14, and the like. The image processing apparatus 1 may be one or more cloud servers or one or more physical servers.

The communicator 14 is a communication interface for connecting the image processing apparatus 1 to a network N1 in a wired or wireless manner and executing data communication with external equipment (for example, the training apparatus 2) via the network N1 according to a predetermined communication protocol. The network N1 includes, for example, the Internet, a LAN, or the like.

The operation display 13 is a user interface including a display such as a liquid crystal display or an organic EL display that displays various types of information, and an operation inputter such as a mouse, a keyboard, or a touch panel that receives an operation.

The storage 12 is a non-volatile storage such as a hard disk drive (HDD), a solid state drive (SSD), or a flash memory that stores various types of information. The storage 12 stores a control program such as a character recognition program (an example of an image processing program of the disclosure) for enabling the controller 11 to execute character recognition processing to be described below. For example, the character recognition program is non-transiently recorded in a computer-readable recording medium such as a CD or a DVD, read by a reading apparatus (not illustrated) such as a CD drive or a DVD drive included in the image processing apparatus 1, and stored in the storage 12. Note that the character recognition program may be distributed from a cloud server and stored in the storage 12.

The storage 12 also stores image data (scanned data or the like) of documents or the like acquired from external equipment.

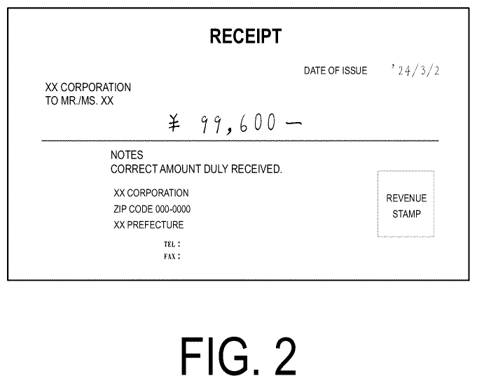

FIG. 2 illustrates a receipt as an example of a document. As illustrated in FIG. 2, the receipt includes multiple items such as date of issue, recipient, contact information of an issuer, and the amount of money. For example, a user scans the receipt using a scanner, a multi-function printer, or the like and uploads the image data (input image) to the image processing apparatus 1. The user also photographs the receipt by using an operation terminal (for example, a smartphone) and uploads the image data to the image processing apparatus 1. Upon acquiring the image data of the receipt, the controller 11 stores the image data in the storage 12. As another embodiment, the controller 11 may acquire a document file of the receipt created in the external equipment and store the document file in the storage 12.

The controller 11 includes control equipment such as a central processing unit (CPU), a read only memory (ROM), and a random access memory (RAM). The CPU is a processor that executes various types of arithmetic processing. The ROM stores in advance control programs such as a BIOS and an OS for causing the CPU to execute various types of processing. The RAM stores various types of information and is used as a temporary storage memory (work area) for the various types of processing executed by the CPU. The controller 11 controls the image processing apparatus 1 by causing the CPU to execute various types of the control programs stored in advance in the ROM or the storage 12.

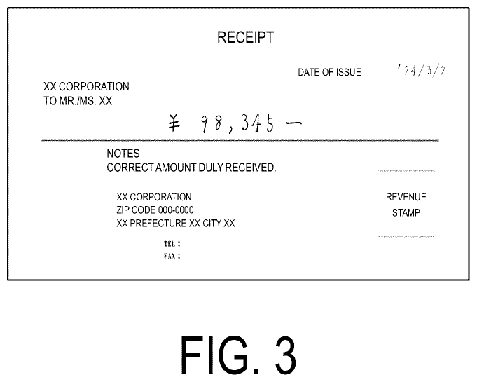

However, in the related art, when a handwritten character sequence includes a small-size handwritten character such as a comma, a period, or a punctuation mark, there may be a problem that such a small-size handwritten character is misrecognized as a large-size character. For example, such problems arise when the character sequence “¥99,600-” included in the input image as illustrated in FIG. 2 is subjected to OCR processing, the comma “,” may be misrecognized as “9” and thus “¥999600-” is output as the OCR result, or when the character sequence “¥98,345-” as illustrated in FIG. 3 is subjected to the OCR processing, the comma “,” may be misrecognized as “1” and thus “¥981345-” is output as an OCR result. To solve the problems, the image processing apparatus 1 according to the disclosure has a configuration capable of improving the character recognition accuracy for character sequences including small-size handwritten characters as will be described below.

Specifically, the controller 11 includes various processing units such as an acquisition processing unit 111, a character sequence extraction processing unit 112, a one-character extraction processing unit 113, a correction processing unit 114, a recognition processing unit 115, and an output processing unit 116 as illustrated in FIG. 1. Note that the controller 11 functions as the various processing units by executing various types of processing in accordance with the character recognition program. Further, some or all of the processing units included in the controller 11 may be constituted by an electronic circuit. Note that the character recognition program may be a program for causing a plurality of processors to function as the various types of processing units.

The acquisition processing unit 111 acquires input images. Specifically, the acquisition processing unit 111 acquires an image for character recognition (character image data). For example, the acquisition processing unit 111 acquires character image data of form images containing handwritten characters such as a receipt illustrated in FIG. 2.

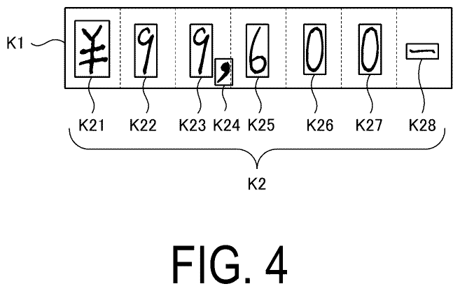

The character sequence extraction processing unit 112 extracts a character-sequence rectangle corresponding to a character sequence constituted by a plurality of characters from the input image. Specifically, the character sequence extraction processing unit 112 executes recognition processing of a document part in the input image acquired by the acquisition processing unit 111 to execute character sequence recognition processing for recognizing a character sequence constituted by a plurality of characters. In addition, the character sequence extraction processing unit 112 sets a character-sequence rectangle corresponding to the recognized character sequence. That is, the character sequence extraction processing unit 112 recognizes a cluster of a plurality of characters as a character-sequence rectangle. For example, from the input image illustrated in FIG. 2, the character sequence extraction processing unit 112 extracts a character-sequence rectangle K1 (see FIG. 4) corresponding to a handwritten character sequence (“¥99,600-”). The character sequence extraction processing unit 112 is an example of a first extraction processing unit of the disclosure.

The one-character extraction processing unit 113 extracts a plurality of one-character rectangles corresponding to each of the plurality of characters from the input image. Specifically, the one-character extraction processing unit 113 performs one-character recognition processing of recognizing characters in single character units in the input image acquired by the acquisition processing unit 111. In addition, the one-character extraction processing unit 113 extracts one-character rectangles corresponding to the recognized characters. That is, the one-character extraction processing unit 113 recognizes smallest units of characters as character-sequence rectangles. Note that, the one-character extraction processing unit 113 may extract a plurality of one-character rectangles corresponding, respectively, to a plurality of characters from the character sequence extracted by the character sequence extraction processing unit 112.

For example, the one-character extraction processing unit 113 extracts a plurality of one-character rectangles K2 corresponding, respectively, to the characters as illustrated in FIG. 4. FIG. 4 illustrates an example in which eight one-character rectangles K21 to K28 have been extracted from the character-sequence rectangle K1. The one-character extraction processing unit 113 is an example of a second extraction processing unit of the disclosure.

When a specific one-character rectangle (hereinafter referred to as a “specific character rectangle”) whose position and size satisfy predetermined conditions is included in the plurality of one-character rectangles, the correction processing unit 114 corrects the specific character rectangle. The correction processing unit 114 identifies a one-character rectangle with a character in a small size that is likely to be misrecognized as a specific character rectangle, and executes correction processing on the specific character rectangle.

Specifically, the correction processing unit 114 determines whether the plurality of one-character rectangles include a one-character rectangle having a rectangular area smaller than a predetermined area (first condition), and whether the plurality of one-character rectangles include a one-character rectangle positioned at or beyond a predetermined distance from the outer side of the character-sequence rectangle K1 (second condition).

Then, if the plurality of one-character rectangles include a one-character rectangle having a rectangular area smaller than the predetermined area (when the first condition is satisfied) and positioned at or beyond the predetermined distance from the outer side of the character-sequence rectangle K1 (when the second condition is satisfied), the correction processing unit 114 identifies the one-character rectangle as a specific character rectangle and corrects the specific character rectangle.

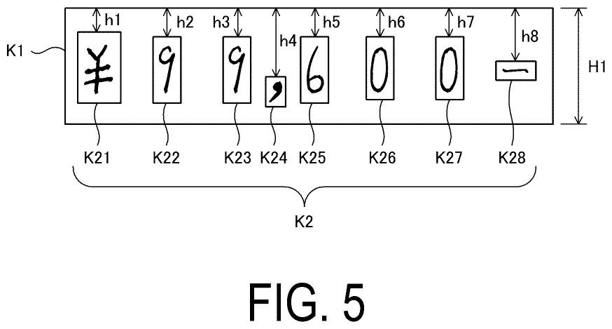

In the example illustrated in FIG. 5, the correction processing unit 114 calculates the areas M1 to M8 of the eight one-character rectangles K21 to K28, respectively, and the mean area Ma of the one-character rectangles K21 to K28. In addition, the correction processing unit 114 calculates a reference area Mb (=Ma× F1) obtained by multiplying the mean area Ma by a correction coefficient F1 (for example, F1=0.3). Then, the correction processing unit 114 identifies a one-character rectangle having an area smaller than the reference area Mb among the areas M1 to M8. Here, the correction processing unit 114 identifies the one-character rectangle K24 (“,”) having an area M4 smaller than the reference area Mb among the areas M1 to M8. In this manner, the correction processing unit 114 determines whether the one-character rectangles K21 to K28 include a one-character rectangle having an area smaller than 30% of the mean area. Note that the correction coefficient F1 is not limited to 0.3, and is set to a value in the range of 0.1 to 0.3, for example.

In addition, in the example illustrated in FIG. 5, the correction processing unit 114 calculates each of heights (distances) h1 to h8 of the eight one-character rectangles K21 to K28 from the upper side of the character-sequence rectangle K1 and a height H1 of the character-sequence rectangle K1. In addition, the correction processing unit 114 calculates a reference height H2 (=H1×F2) by multiplying the height H1 of the character-sequence rectangle K1 by a correction coefficient F2 (for example, F2=0.5). Then, the correction processing unit 114 identifies a one-character rectangle having a height equal to or higher than the reference height H2 among the heights h1 to h8. Here, the correction processing unit 114 identifies a one-character rectangle K24 (“,”) having the height h4 that is equal to or higher than the reference height H2 (=H1×0.5) among the heights h1 to h8. As described above, the correction processing unit 114 determines whether the one-character rectangles K21 to K28 include a one-character rectangle whose height (distance) from the upper side of the character-sequence rectangle K1 is 50% or more of the height of the character-sequence rectangle K1.

That is, the correction processing unit 114 identifies the one-character rectangle positioned in the lower-half region of the character-sequence rectangle K1. Note that the correction coefficient F2 is not limited to 0.5, and is set to a value in the range of 0.5 to 0.9, for example.

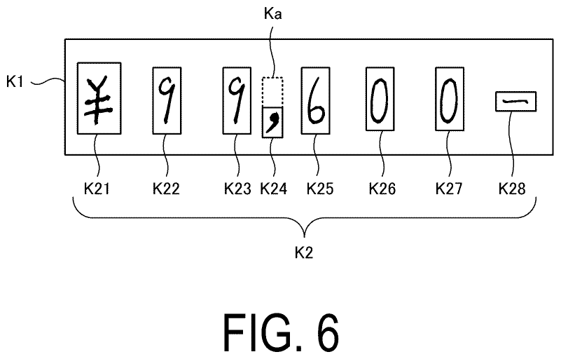

As described above, the correction processing unit 114 identifies, from among the plurality of one-character rectangles K2 included in the character-sequence rectangle K1, a specific character rectangle satisfying the first condition and the second condition. Then, the correction processing unit 114 executes correction processing on the identified specific character rectangle. Specifically, the correction processing unit 114 adds a margin (margin rectangle) of a predetermined size to the specific character rectangle. For example, the correction processing unit 114 adds a margin having the same size as the size of the specific character rectangle. In the example illustrated in FIG. 6, the correction processing unit 114 adds a margin Ka at the same height h4 as that of the specific character rectangle K24 to the specific character rectangle K24. In addition, the correction processing unit 114 adds a margin Ka in a direction (here, the upward direction) orthogonal to the arrangement direction (the left-right direction in FIG. 6) of the plurality of one-character rectangles K21 to K28. In addition, the correction processing unit 114 may add a margin whose height when the margin rectangle is added to the specific character rectangle is smaller than the reference height H2 (=H1× F2). That is, the correction processing unit 114 may perform correction to add a margin to the one-character rectangle so that the distance from the outer side of the character-sequence rectangle K1 to the corrected one-character rectangle is shorter than the reference height H2.

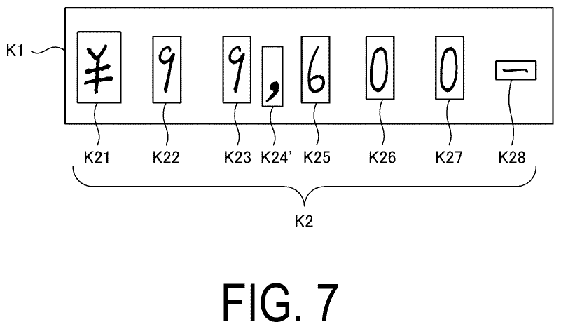

In this manner, the correction processing unit 114 corrects the specific character rectangle K24 by adding the margin Ka to the specific character rectangle K24. FIG. 7 illustrates the corrected specific character rectangle K24 (hereinafter, referred to as a “specific character rectangle K24′”).

Note that, the size (height) of the margin Ka is not limited to the height h4 that is the same as the height of the specific character rectangle K24, and may be, for example, a difference between the mean height of the one-character rectangles K21 to K28 and the height h4 of the specific character rectangle K24. This makes it possible to adjust the height calculated by adding the margin Ka to the specific character rectangle K24 to the mean height of the one-character rectangles K21 to K28.

The recognition processing unit 115 executes character recognition processing (OCR processing) on the character sequence. Specifically, the recognition processing unit 115 executes OCR processing on the character sequence using the corrected specific character rectangle corrected by the correction processing unit 114. For example, the recognition processing unit 115 executes the OCR processing based on the character-sequence rectangle K1 extracted by the character sequence extraction processing unit 112, the plurality of one-character rectangles K2 extracted by the one-character extraction processing unit 113, and the one-character rectangle K2 corrected by the correction processing unit 114 (the specific character rectangle K24′ in FIG. 7).

For example, the recognition processing unit 115 executes pre-processing (processing such as background removal, inversion, ruled line removal, seal removal, and italic correction) for improving the accuracy of OCR, and then executes the existing OCR processing.

The output processing unit 116 outputs the OCR result (character recognition result). For example, the output processing unit 116 outputs the OCR result to the request source that has output the character recognition request for the input image.

In addition, the output processing unit 116 outputs training data to the training apparatus 2 (see FIG. 1). The controller 11 generates the corrected specific character rectangle corrected by the correction processing unit 114 as training data used for machine learning. The output processing unit 116 outputs training data (teacher data) including the one-character rectangle K24 (“,”) for which the correction processing unit 114 has executed the correction processing and the corrected specific character rectangle K24′ to the training apparatus 2.

The training apparatus 2 performs machine learning using the training data generated by the image processing apparatus 1 to generate a trained model.

Note that the machine learning involves algorithms such as supervised learning using supervised data, unsupervised learning using unsupervised data, and reinforcement learning. Further, in order to realize these techniques, a method called “deep learning” is used in which extraction of a feature amount itself is learned. In the present embodiment, the training apparatus 2 includes a trained model based on the various algorithms described above. By performing machine learning using supervised data and unsupervised data as input data, the training apparatus 2 can generate a trained model for executing character recognition processing.

The trained model can be applied to the image processing apparatus 1. For example, as illustrated in FIG. 1, when an input image for character recognition is input to the image processing apparatus 1, the image processing apparatus 1 performs OCR processing on the input image using the trained model to output an OCR result. The image processing apparatus 1 is an example of the output apparatus of the disclosure.

In addition, the trained model may be downloaded to the image processing apparatus 1 for use, or may be stored in a server (cloud server) and used by accessing the server from a user terminal via the Internet or the like. For example, when an arbitrary input image is input to a user terminal, the trained model outputs an optimal character recognition result. That is, the user terminal may execute the OCR processing on the input image using the trained model generated by the training apparatus 2 and output the OCR result. In addition, the user terminal may include a controller that presents, to the user, an OCR result obtained by executing the OCR processing on the character sequence using the corrected specific character rectangle corrected in the image processing apparatus 1. The user terminal is an example of the output apparatus of the disclosure.

### Character Recognition Processing

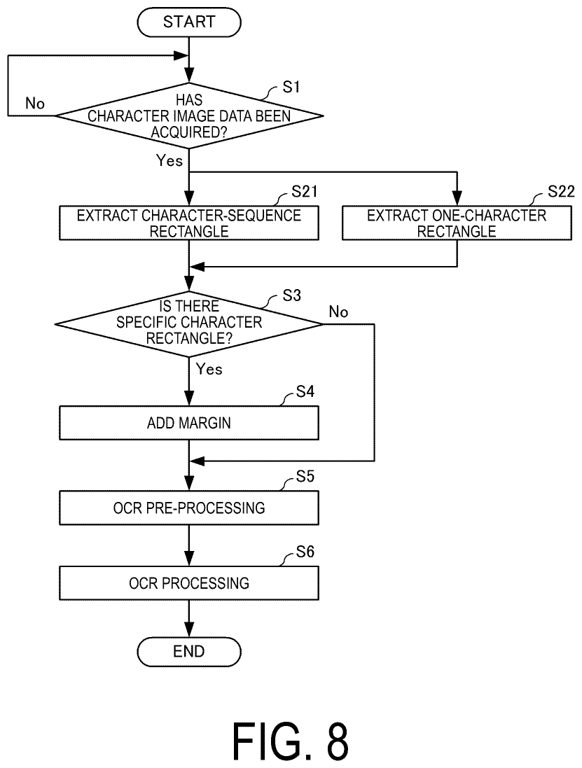

FIG. 8 is a flowchart illustrating an example of the procedure of the character recognition processing executed in the image processing apparatus 1.

Note that the disclosure can be understood as a character recognition method (image processing method of the disclosure) in which one or more steps included in the character recognition processing are executed. In addition, one or more steps included in the character recognition processing described herein may be omitted as appropriate. In addition, each of the steps of the character recognition processing may be executed in a different order to the extent that similar effects are obtained. Furthermore, although the example in which the controller 11 of the image processing apparatus 1 executes each of the steps of the character recognition processing has been exemplified in the embodiment, in another embodiment, one or more processors may execute each of the steps of the character recognition processing in a distributed manner. In addition, when acquiring character image data from external equipment, the controller 11 can execute the character recognition processing in parallel for each piece of character image data.

### Step S1

In step S1, the controller 11 determines whether character image data has been acquired. Specifically, the controller 11 acquires character image data of a form containing handwritten characters (for example, the receipt in FIG. 2) from external equipment or the like. Upon acquiring character image data (S1: Yes), the controller 11 proceeds to the processing of steps S21 and S22. The controller 11 awaits until character image data is acquired (S1: No).

### Step S21

In step S21, the controller 11 extracts a character-sequence rectangle corresponding to a character sequence constituted by a plurality of characters from the character image data. To be specific, the controller 11 executes recognition processing on a document part of the input image to recognize a character sequence constituted by a plurality of characters, and extracts a character-sequence rectangle K1 corresponding to the recognized character sequence. For example, the controller 11 extracts the character-sequence rectangle K1 corresponding to a handwritten character sequence (“¥99,600-”) from the input image illustrated in FIG. 2.

### Step S22

In step S22, the controller 11 extracts a plurality of one-character rectangles corresponding to a plurality of characters, respectively, from the character image data. To be specific, the controller 11 recognizes the characters in single character units in the input image and extracts one-character rectangles K2 corresponding to the recognized characters. For example, as illustrated in FIG. 4, the controller 11 extracts eight one-character rectangles K21 to K28 from the character-sequence rectangle K1.

The controller 11 executes the processing of steps S21 and S22 in parallel. As another embodiment, the controller 11 may execute the processing of step S22 after step S21. After steps S21 and S22, the controller 11 proceeds to the processing of step S3.

### Step S3

In step S3, the controller 11 determines whether the one-character rectangle to be corrected (specific character rectangle) is included in the plurality of one-character rectangles extracted in step S22. Specifically, the controller 11 determines whether the plurality of one-character rectangles include the specific character rectangle whose position and size satisfy predetermined conditions.

For example, the controller 11 determines whether the plurality of one-character rectangles include a one-character rectangle having a rectangular area smaller than a predetermined area (reference area Mb) (first condition), and whether the plurality of one-character rectangles include a one-character rectangle positioned at or beyond a predetermined distance (reference height H2) from an outer side (for example, the upper side) of the character-sequence rectangle K1 (second condition).

For example, the controller 11 sets the value obtained by multiplying the mean area Ma of the one-character rectangles K21 to K28 by the correction coefficient F1 (for example, F1=0.3) as the reference area Mb (=Ma×F1). In the example illustrated in FIG. 5, the rectangular area M4 of the one-character rectangle K24 among the plurality of one-character rectangles K21 to K28 is smaller than the reference area Mb.

In addition, for example, the controller 11 sets the value obtained by multiplying the height H1 of the character-sequence rectangle K1 by the correction coefficient F2 (for example, F2=0.5) as the reference height H2 (=H1×F2). In the example illustrated in FIG. 5, the height h4 of the one-character rectangle K24 among the plurality of one-character rectangles K21 to K28 from the upper side of the character-sequence rectangle K1 is equal to or higher than the reference height H2.

In the example shown in FIG. 5, since the first condition and the second condition are satisfied, the controller 11 determines that the one-character rectangle to be corrected (specific character rectangle K24) is included in the plurality of one-character rectangles K21 to K28. Upon determining that the specific character rectangle is included in the plurality of one-character rectangles (S3: Yes), the controller 11 proceeds to the processing of step S4. On the other hand, upon determining that the specific character rectangle is not included in the plurality of one-character rectangles (S3: No), the controller 11 proceeds to the processing of step S5. For example, the controller 11 determines that the specific character rectangle is not included in the plurality of one-character rectangles when the plurality of one-character rectangles do not include a one-character rectangle having a rectangular area smaller than a predetermined area (reference area Mb) (when the first condition is not satisfied), or when the plurality of one-character rectangles do not include a one-character rectangle positioned at or beyond a predetermined distance (reference height H2) from the outer side (for example, the upper side) of the character-sequence rectangle K1 (when the second condition is not satisfied).

As another embodiment, the controller 11 may adopt either one of the first condition and the second condition in step S3.

### Step S4

In step S4, the controller 11 executes correction processing of adding a margin to the specific character rectangle. Specifically, the controller 11 adds a margin in a predetermined size to the specific character rectangle. In the example illustrated in FIG. 6, for example, the controller 11 adds a margin Ka at the same height h4 as that of the specific character rectangle K24 to the top of the specific character rectangle K24.

### Step S5

In step S5, the controller 11 executes pre-processing of OCR processing. Specifically, the controller 11 executes existing pre-processing such as background removal, inversion, ruled line removal, seal removal, and italic correction. For example, if the plurality of one-character rectangles extracted in step S22 do not include a specific character rectangle (S3: No), the controller 11 executes OCR pre-processing based on the character-sequence rectangle K1 extracted in step S21 and the plurality of one-character rectangles K2 extracted in step S22. On the other hand, if the plurality of one-character rectangles extracted in step S22 include a specific character rectangle (S3: Yes), the controller 11 executes OCR pre-processing based on the character-sequence rectangle K1 extracted in step S21, the plurality of one-character rectangles K2 extracted in step S22 and the one-character rectangle K2 extracted in step S4 (specific character rectangle K24′ to which the margin Ka has been added).

### Step S6

In step S6, the controller 11 executes OCR processing. The controller 11 executes the existing OCR processing on the character-sequence rectangle and the one-character rectangle that have undergone the pre-processing of the OCR processing. When the OCR processing is executed, the controller 11 outputs the OCR result.

As described above, the controller 11 executes the character recognition processing. In addition, the controller 11 repeatedly executes the character recognition processing each time character image data (input image) for character recognition is acquired.

As described above, the image processing apparatus 1 according to the present embodiment acquires character image data, extracts a character-sequence rectangle corresponding to a character sequence constituted by a plurality of characters from the character image data, and extracts a plurality of one-character rectangles corresponding to each of the plurality of characters from the character image data. In addition, if a specific one-character rectangle whose position and size satisfy a predetermined condition is included in the plurality of one-character rectangles, the image processing apparatus 1 corrects the specific one-character rectangle, and executes character recognition processing (OCR processing) on the character sequence using the corrected specific one-character rectangle.

According to the above configuration, for example, when a handwritten character sequence includes small-size handwritten characters such as a comma, a period, and a punctuation mark, the OCR processing is executed by performing correction processing on the one-character rectangles of those small-size handwritten characters according to the positions and the sizes of the one-character rectangles. Accordingly, the positions and sizes of the small-size handwritten characters can be appropriately recognized, and consequently the character recognition accuracy of the character sequence containing the small-size handwritten characters can be improved.

### Other Embodiments

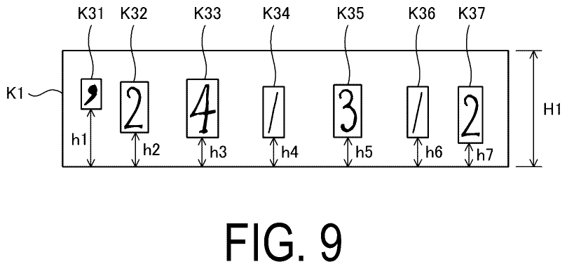

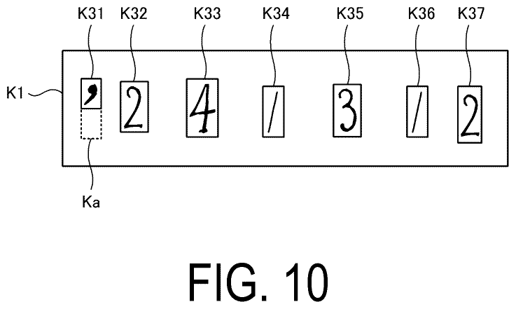

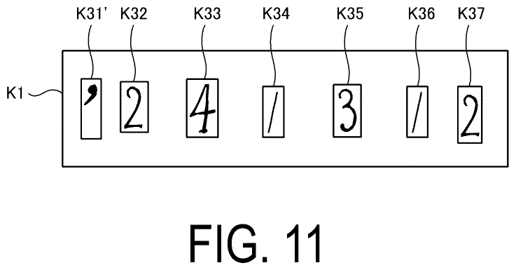

Although the example in which the one-character rectangles K2 are positioned on the lower side of the character-sequence rectangle K1 (see FIG. 4 and the like) is shown in the above-described embodiment, the disclosure is not limited thereto, and the OCR processing can be executed in the same processing even when the one-character rectangles K2 are positioned on the upper side of the character-sequence rectangle K1. For example, FIG. 9 illustrates handwritten characters of year, month, and date “'24/3/2” (for example, “Date of Issue” in FIG. 2). Note that “'24” is an abbreviation of “2024”. The controller 11 extracts a character-sequence rectangle K1 and one-character rectangles K31 to K37 from the input image. When a one-character rectangle is positioned on the upper side of the character-sequence rectangle K1 as illustrated in FIG. 9, the controller 11 determines whether the one-character rectangle is positioned at or beyond a predetermined distance (reference height H2) from the lower side of the character-sequence rectangle K1 under the second condition. If the one-character rectangle K31 satisfies the first condition and is positioned at or beyond the reference height H2 (=H1×0.5) from the lower side of the character-sequence rectangle K1 (if the second condition is satisfied), the controller 11 adds a margin Ka to the bottom of the one-character rectangle K31 as illustrated in FIG. 10. Then, the controller 11 executes OCR processing based on the character-sequence rectangle K1, the one-character rectangles K31 to K37, and a specific character rectangle K31′ with the margin Ka added (see FIG. 11).

As described above, the controller 11 may determine whether the one-character rectangle satisfying the first condition is positioned on the upper side or the lower side of the character-sequence rectangle K1, and may determine the second condition based on the height (distance) from the upper side of the character-sequence rectangle K1 when the one-character rectangle is positioned on the lower side (see FIG. 5), and may determine the second condition based on the height (distance) from the lower side of the character-sequence rectangle K1 when the one-character rectangle is positioned on the upper side (see FIG. 9).

As another embodiment, the controller 11 may determine the second condition based on the height (distance) from the lower side of the character-sequence rectangle K1 when the one-character rectangle satisfying the first condition is positioned on the lower side of the character-sequence rectangle K1, and may determine the second condition based on the height (distance) from the upper side of the character-sequence rectangle K1 when the one-character rectangle is positioned on the upper side. In this case, the controller 11 determines whether the height from the outer side of the character-sequence rectangle K1 is smaller than the reference height H2 (=H1×F2). In addition, the correction coefficient F2 is set to a value in the range of 0.1 to 0.5, for example.

As another embodiment, when a plurality of one-character rectangles K2 included in the character-sequence rectangle K1 are arranged vertically, the controller 11 may determine whether a one-character rectangle satisfying the first condition is positioned on the right side or the left side of the character-sequence rectangle K1, may determine the second condition based on the width (distance) from the left side of the character-sequence rectangle K1 when the one-character rectangle is positioned on the right side, and may determine the second condition based on the width (distance) from the right side of the character-sequence rectangle K1 when the one-character rectangle is positioned on the left side.

As another embodiment, when a specific one-character rectangle whose position and size satisfy a predetermined condition is included in a plurality of one-character rectangles, the image processing apparatus 1 may correct the specific one-character rectangle, and execute character recognition processing (OCR processing) on the character sequence using the corrected specific one-character rectangle. In particular, when a plurality of one-character rectangles include a one-character rectangle positioned at or beyond a predetermined distance from the outer side of the character-sequence rectangle K1 (when the second condition is satisfied), the image processing apparatus 1 may identify the one-character rectangle as a specific character rectangle and correct the specific character rectangle. As another embodiment, when the area of a one-character rectangle among a plurality of one-character rectangles is smaller than a predetermined area (when the first condition is satisfied), the image processing apparatus 1 may identify the one-character rectangle as a specific character rectangle and correct the specific character rectangle. That is, the image processing apparatus 1 according to the disclosure may specify and correct an identified character rectangle when at least one of the first condition and the second condition is satisfied.

In the present embodiment, a specific character corresponding to the specific character rectangle is at least one of a comma, a period, an apostrophe, a quotation mark, a punctuation mark, a small character, a subscript, and a superscript, for example. According to the configuration of the disclosure, these specific characters can be correctly recognized. In addition, the specific character may be a lowercase of alphabets. For example, when a character sequence includes a lower case “c”, the configuration of the disclosure ensures that the character “c” is correctly recognized as a lowercase “c”, instead of misrecognizing the character “c” as an uppercase “C”. In addition, the specific characters are not limited to Japanese language and alphabets (English letters), and may be characters of other languages.

In addition, in the image processing system 10, the image processing apparatus 1 and the training apparatus 2 may be configured as integrated equipment. In addition, the processing units (the acquisition processing unit 111, the character sequence extraction processing unit 112, the one-character extraction processing unit 113, the correction processing unit 114, the recognition processing unit 115, and the output processing unit 116) of the image processing apparatus 1 may be arranged in multiple pieces of equipment in a distributed manner.

### Supplementary Notes of Disclosure

Hereinafter, an outline of the disclosure extracted from the above-described embodiments will be described as supplementary notes. Note that configurations and processing functions described in the following supplementary notes can be selected and combined as desired.

### Supplementary Note 1

An image processing apparatus comprising:
an acquisition processing circuit that acquires character image data;
a first extraction processing circuit that extracts a character-sequence rectangle corresponding to a character sequence composed of a plurality of characters from the character image data;
a second extraction processing circuit that extracts a plurality of one-character rectangles corresponding to the plurality of characters, respectively, from the character image data;
a correction processing circuit that corrects a specific one-character rectangle when the plurality of one-character rectangles include the specific one-character rectangle, at least one of a position and a size of the specific one-character rectangle satisfying a predetermined condition; and
a recognition processing circuit that executes character recognition processing on the character sequence using the specific one-character rectangle corrected by the correction processing circuit.

### Supplementary Note 2

The image processing apparatus described in Supplementary Note 1, in which the correction processing circuit adds a margin of a predetermined size to the specific one-character rectangle.

### Supplementary Note 3

The image processing apparatus described in Supplementary Note 2, in which the correction processing circuit adds the margin in the same size as the size of the specific one-character rectangle.

### Supplementary Note 4

The image processing apparatus described in Supplementary Note 2, in which the correction processing circuit adds the margin corresponding to a difference between a mean height of the plurality of one-character rectangles and a height of the specific one-character rectangle.

### Supplementary Note 5

The image processing apparatus described in any one of Supplementary Notes 2 to 4, in which the correction processing circuit adds the margin in a direction orthogonal to an arrangement direction of the plurality of one-character rectangles.

### Supplementary Note 6

The image processing apparatus described in any one of Supplementary Notes 1 to 5, in which, among the plurality of one-character rectangles, the correction processing circuit corrects a one-character rectangle of which an area of the rectangle is smaller than a predetermined area and which is positioned at or beyond a predetermined distance from an outer side of the character-sequence rectangle.

### Supplementary Note 7

The image processing apparatus described in Supplementary Note 6, in which the correction processing circuit performs correction to add a margin to the one-character rectangle so that a distance from the outer side to the corrected one-character rectangle is shorter than the predetermined distance.

### Supplementary Note 8

The image processing apparatus described in any one of Supplementary Notes 1 to 7, in which the specific one-character rectangle is at least one of a comma, a period, an apostrophe, a quotation mark, a punctuation mark, and a small character.

### Supplementary Note 9

The image processing apparatus described in any one of Supplementary Notes 1 to 8, in which the specific one-character rectangle corrected by the correction processing circuit is generated as training data used for machine learning.

### Supplementary Note 10

An image processing system comprising:
the image processing apparatus described in Supplementary Note 9; and
a training apparatus that generates a trained model by performing machine learning using the training data generated by the image processing apparatus.

### Supplementary Note 11

An output apparatus that executes character recognition processing on an input image using the trained model generated by the training apparatus described in Supplementary Note 10 and outputs a character recognition result.

### Supplementary Note 12

An output apparatus comprising a controller that presents, to a user, a character recognition result obtained by executing character recognition processing on the character sequence using the specific one-character rectangle corrected in the image processing apparatus described in any one of Supplementary Notes 1 to 9.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image processing apparatus comprising:
one or more processors; and
one or more memories that stores a computer-readable instruction for causing, when executed by the one or more processors, the one or more processors to:
acquire character image data;
extract a character-sequence rectangle corresponding to a character sequence composed of a plurality of characters from the character image data;
extract a plurality of one-character rectangles corresponding to the plurality of characters, respectively, from the character image data;
correct a specific one-character rectangle when the plurality of one-character rectangles include the specific one-character rectangle, at least one of a position and a size of the specific one-character rectangle satisfying a predetermined condition; and
execute character recognition processing on the character sequence using the corrected specific one-character rectangle.

2. The image processing apparatus according to claim 1,
wherein the one or more processors add a margin of a predetermined size to the specific one-character rectangle.

3. The image processing apparatus according to claim 2,
wherein the one or more processors add the margin in the same size as the size of the specific one-character rectangle.

4. The image processing apparatus according to claim 2,
wherein the one or more processors add the margin corresponding to a difference between a mean height of the plurality of one-character rectangles and a height of the specific one-character rectangle.

5. The image processing apparatus according to claim 2,
wherein the one or more processors add the margin in a direction orthogonal to an arrangement direction of the plurality of one-character rectangles.

6. The image processing apparatus according to claim 1,
wherein the one or more processors correct, among the plurality of one-character rectangles, a one-character rectangle of which an area of the rectangle is smaller than a predetermined area and which is positioned at or beyond a predetermined distance from an outer side of the character-sequence rectangle.

7. The image processing apparatus according to claim 6,
wherein the one or more processors perform correction to add a margin to the one-character rectangle so that a distance from the outer side to the corrected one-character rectangle is shorter than the predetermined distance.

8. The image processing apparatus according to claim 1,
wherein the specific one-character rectangle is at least one of a comma, a period, an apostrophe, a quotation mark, a punctuation mark, and a small character.

9. The image processing apparatus according to claim 1, wherein the one or more processors generate, as training data used for machine learning, the corrected specific one-character rectangle.

10. An image processing system comprising:
the image processing apparatus according to claim 9; and
a training apparatus that generates a trained model by performing machine learning using the training data generated by the image processing apparatus.

11. An output apparatus that executes character recognition processing on an input image using the trained model generated by the training apparatus according to claim 10 and outputs a character recognition result.

12. An output apparatus that presents, to a user, a character recognition result obtained by executing character recognition processing on the character sequence using the specific one-character rectangle corrected in the image processing apparatus according to claim 1.

13. An image processing method performed by one or more processors, the image processing method comprising:
acquiring character image data;
extracting a character-sequence rectangle corresponding to a character sequence composed of a plurality of characters from the character image data;
extracting a plurality of one-character rectangles corresponding to the plurality of characters, respectively, from the character image data;
correcting a specific one-character rectangle when the plurality of one-character rectangles include the specific one-character rectangle, at least one of a position and a size of the specific one-character rectangle satisfying a predetermined condition; and
executing character recognition processing on the character sequence using the corrected specific one-character rectangle.

14. A non-transitory computer-readable recording medium in which an image processing program is recorded, the image processing program causing one or more processors to:
acquire character image data;
extract a character-sequence rectangle corresponding to a character sequence composed of a plurality of characters from the character image data;
extract a plurality of one-character rectangles corresponding to the plurality of characters, respectively, from the character image data;
correct a specific one-character rectangle when the plurality of one-character rectangles include the specific one-character rectangle, at least one of a position and a size of the specific one-character rectangle satisfying a predetermined condition; and
execute character recognition processing on the character sequence using the corrected specific one-character rectangle.
